(19) United States
(12) Patent Application Publication
(10) Pub. No.: US 2011/0156409 A1
(43) Pub. Date: Jun. 30, 2011

(54) DOOR GUARD

(76) Inventor: Francisco J. Alvarenga, (US)

(21) Appl. No.: 12/649,353

(22) Filed: Dec. 30, 2009

(51) Int. Cl. E05C 1/10

(52) U.S. Cl. 292/175

(57) ABSTRACT

A security door guard to prevent forced entry into a home, comprised of two metal plates and a pin. The door guard includes a lock assembly employing cooperating metal like plates, one secured to the inside of the door jamb and the other secured to the inside of the swinging side of the door. Said metal plates being interlocked with a removable cylindrical pin and having ears bent towards the door jamb. The pin comprised of a stud head and two arms that extend downward on each side.

### FIELD

The present invention relates generally to a door guard. More specifically it refers to an apparatus for protecting the door from being opened by forced entry. The apparatus is an effective device that is applied to the swinging side of the door and the door jamb so to protect forced entry into a home. It is applicable to any door, intended for higher security to prevent intruders from a forced entry into the home.

### DESCRIPTION OF A PRIOR ART

Doors are designed in such a way that they are mounted onto the wall and held in place with about three hinges. The swinging side of the door usually is comprised of a lock so to prevent forced entry. Prior art has been created to create an enhanced security. In the past, inventors have created locks, chains, bolts and other such security devices to add extra security to the swinging side of the door. However, the existing products are not secure enough to keep the door closed. A simple kick will lead to additional applied pressure, causing the device to fail. It is, however, generally known that a door cannot be intruded through on the hinge side. The present invention, therefore, focuses on two main aspects. It seeks to create a security lock device that is fail proof and that can be applied to the swinging side of the door. This device was made to meet the needs of the modern dweller who, in these days of high crime, require a strong lock that is easy to install, easy to open in case of emergency and inexpensive.

If no one can break through the hinge side of the door, no one will be able to break through a door guard security device that is hinge-like, but placed on the swinging side of the door. The prior art has failed because the original door hinge as created described in U.S. Pat. No. 1,563,869, by Anders Gustaf Larson, was used on the non-swinging side of the door mainly to hold the door in place and allow it to open and close freely. It was not designed to be a security device to keep the door from being opened by unauthorized entry. It was merely an apparatus used for securing the door in place. Thus, the purpose and scope of the device was entirely different to the present invention.

Various designs for door guards are familiar. In most cases, the security devices previously used were externally used, where overly complicated and required the door jamb be altered in order to work. Moreover, previous art was imprecise, and would cause problems with measurements and in some cases would not allow the door to appropriately close. Previous door security devices were designed in such a way that it would not withstand the weight of kick from an intruder. Thus, with some pressure, the weakness of the invention is seen in that the two pieces can be separated and entrance into the home is gained. Sliding bolts have also been used as security devices but they are unduly large and cause damage to the door.

Examples of door guards described above may be found in the following patents: U.S. Pat. Nos. 1,853,456; 3,405,962; 4,178,027; 4,015,868; 3,592,498; 3,764,173; 4,013,311;

### SUMMARY

In accordance with the invention claimed, it is an object to provide a new door guard that inhibits the forced entry into a home.

It is an object of this invention to provide a door guard which interlocks cooperating metal plates on the door and door jamb so to prevent forced entry.

It is a further object of this invention to provide a door guard device which is uncomplicated, inexpensive, easy to install and very difficult to defeat in the attempt of a forced entry into a home.

It is also an object of the present invention to overcome the weaknesses of the prior art by focusing on making the securing components internal to the door instead of being placed externally on the door jamb and door itself.

It is also an object of the present invention to create a door guard wherein both metal plates have ears that are bent towards the door jamb, so to prevent problems with the closing of the door.

It is a further object of the present invention to create a door guard wherein the metal plates are thicker towards the ears and thinner towards the inside of the door so as to allow the door to close with ease and not get stuck on the metal plates.

It is also an object of the present invention to create a door guard wherein when the metal plates are aligned, when the door is closed, the ears on the plates are designed in such a way as to create even spaces between the ears so to allow the plates to cooperate freely and to be able to withstand the pressure applied from a possible intruder.

Further objects and advantages of the invention will become apparent as the following description proceeds and the features of novelty which characterize this invention will be pointed out with particularity in the claims annexed to and forming part of this specification.

In accordance with the present invention the door is highly secured by the use of two cooperating metal plates. One metal plate is fastened to the inside of the door jamb while the other is secured appositionally to the inside of the door itself. When the door is closed both metal plates align and are interlocked by a cylindrical pin with a stud head and two arms that extend downward on each side. The two metal plates have ears that are bent towards the left, so as to prevent problems with the closing of the door and are made so as to be thicker towards the ears and thinner towards the internal part of the door, so as to allow the door to appropriately open and close.

### BRIEF DESCRIPTION OF THE DRAWINGS

FIG. 1 is a front view of a door and door jamb in closed position illustrating a slightly exploded view of the door lock security mechanism mounted as described and embodying the features of this present invention;

FIG. 2 is an exploded view of the door guard as shown in FIG. 1 in door locked position

FIG. 3 is an exploded view of the door locking mechanism shown in FIG. 1 separated into the two cooperating metal plates and the pin;

FIG. 4 is an exploded front view of the metal plate which attaches to the door jamb

FIG. 5 is an exploded front view of the metal plate which attaches to the door

FIG. 6 Is an exploded view of the pin shown in FIG. 2 interlocking the two cooperating plates;

FIG. 7 is a cross-sectional top front perspective view of the metal plates in the door and door jamb as shown in FIG. 1 when the door is in closed position;

FIG. 8 is a front view of the door guard lock mechanism as shown in FIG. 1 when the door is in closed position;

FIG. 9 is a perspective view of the metal plate as shown in FIGS. 1 and 5 as mounted on the door

FIG. 10 is a perspective view of the metal plate as shown in FIGS. 1 and 4 as mounted on the door jamb.

### DETAILED DESCRIPTION OF THE DRAWINGS

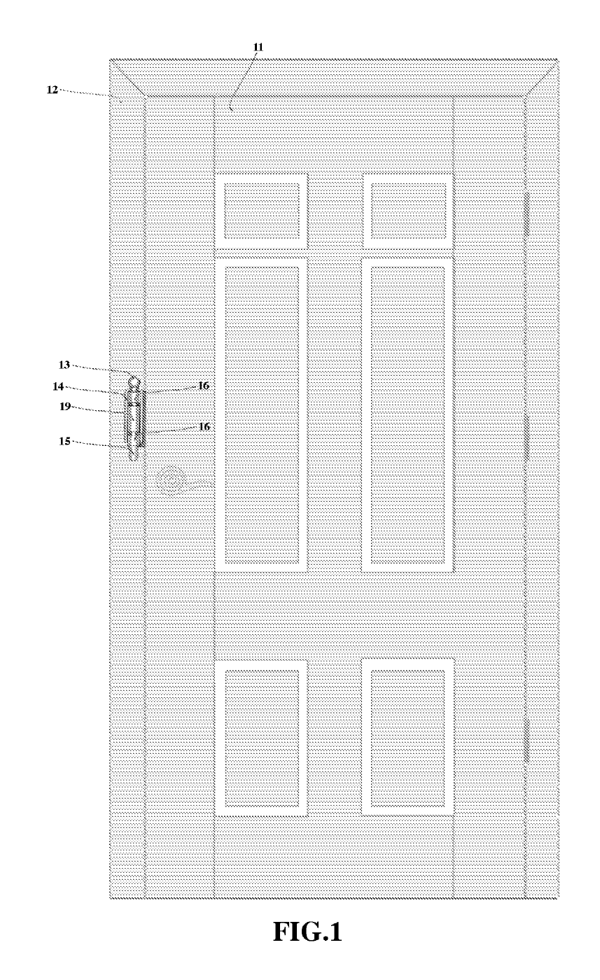

FIG. 1 Displays a front view of a door 11 and its door jamb 12. The door 11 and door jamb 12 as illustrated are only illustrations intended as examples.

FIGS. 1,2 and 8 show the door guard mechanism mounted on the door 11 and door jamb 12.

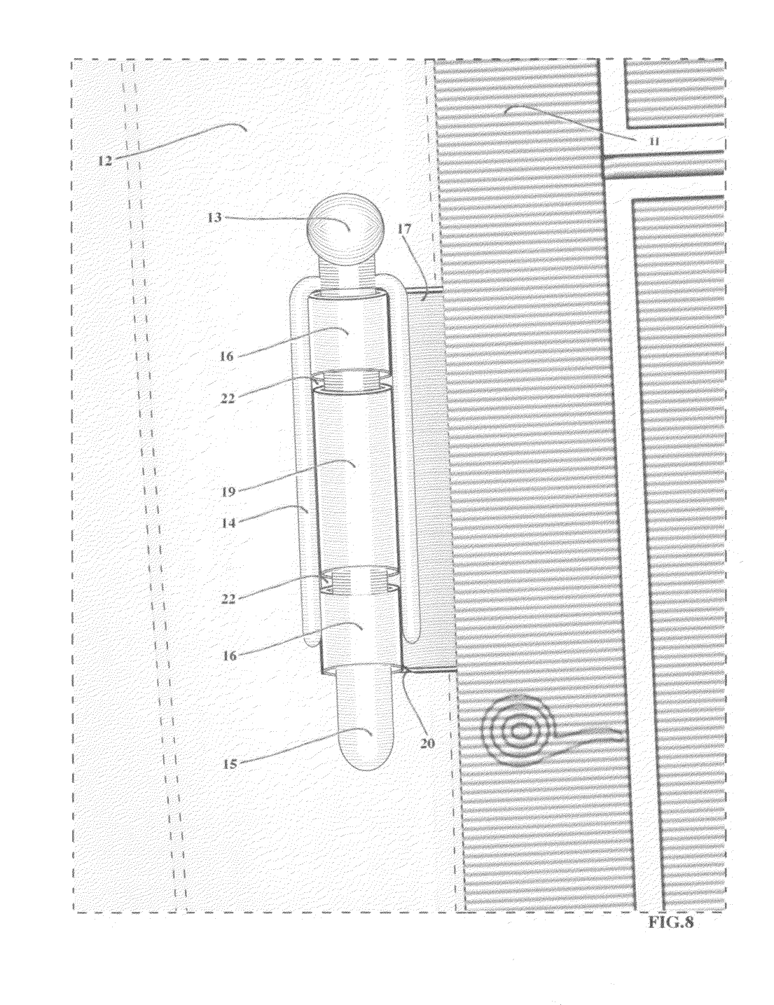

As shown in FIGS. 1, 7 and 8, the metal plate 17 attached to the door 11 and its ears 16 interlock and cooperate with the metal plate 20 attached to the door jamb 12 and its ear 19.

As shown in FIGS. 1,2, and 8, the pin 15 fits through the ears 16 and 19 to secure the metal plates 17 and 20 together when the door 11 is in closed position.

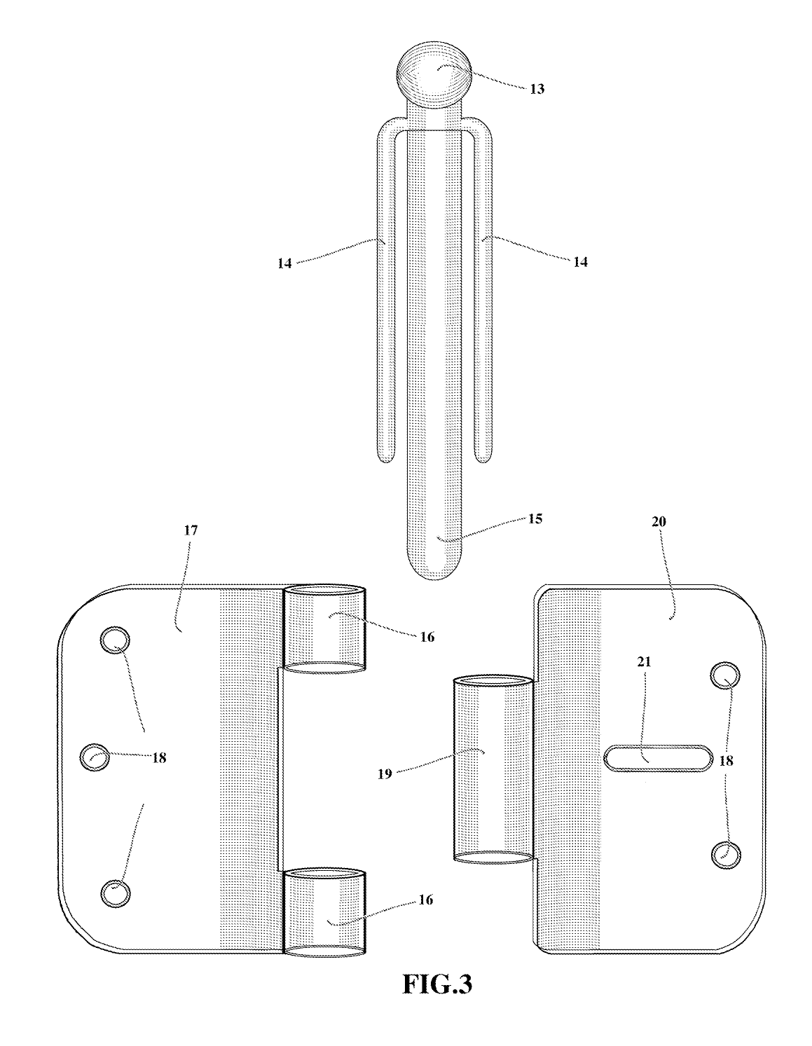

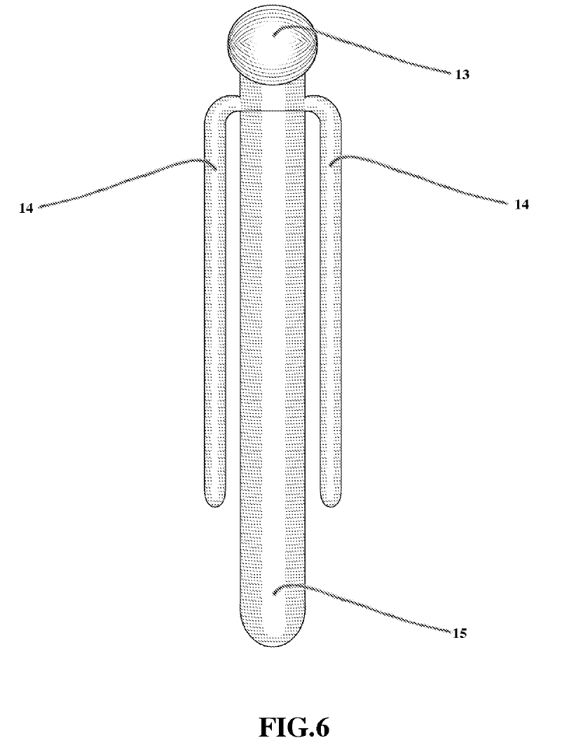

As shown in FIGS. 3 and 6, the pin is comprised of a stud head 13, two downward extending arms 14, and a cylindrical pin body 15. When the locking mechanism is in closed position, as illustrated in FIGS. 1,2, and 8. The cylindrical pin body 15 is inserted through the plate ears 16 and 19.

As shown in FIGS. 1,2, and 8, when the pin 15 is placed through the ears 16 and 19, the stud head 13 protrudes above the ears 16 and 19 and the pin arms 14 extended down-ward outside of the ears 16 and 19 thereby securing the pin 15 in place.

FIGS. 3-6 show each component of the entire locking mechanism. The door lock device is comprised of a metal plate 20 attached to the door jamb 12 which contains an ear 19 and has holes 18 to allow it to be secured to the door jamb 12. This metal plate 20 also has another elongated hole 21 which allows easy alignment to the door jamb. The other metal plate 17 attached to the door 11 contains holes 18 to secure the plate 20 to the door 11. It also has two ears 16.

When the door is in closed position, as illustrated in FIGS. 1,2 and 8, the ears 16 and 19 are held together by a the cylindrical body of the pin 15.

The ear 19 of the metal plate 20 attached to the door jamb 12 is bent outwardly towards the door jamb 12, as illustrated in FIGS. 1,2,3,4,7, 8, and 10. This prevents the ear 19 from getting stuck and causing problems when the door is in closed position, or when the door is opened.

The ears 16 of the metal plate 17 attached to the door 11 is bent outwardly towards the door jamb 12, as illustrated in FIGS. 1,2,3,5,7,8 and 9. This prevents the ears 16 from getting stuck and causing problems when the door is in closed position.

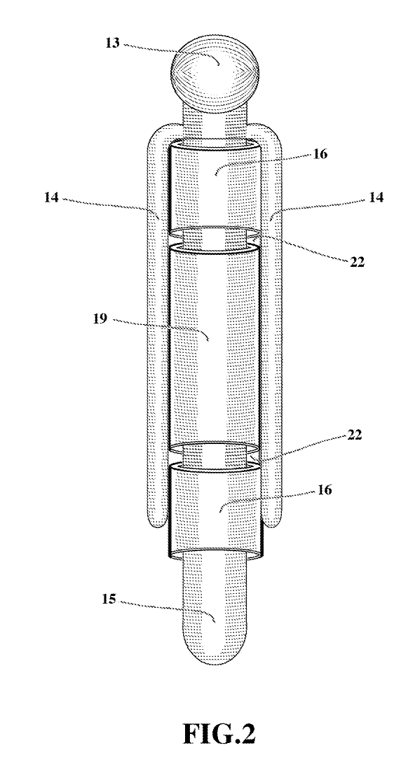

As shown in FIGS. 1 through 6, the metal plate 20 attached to the door jamb 12 and the metal plate 17 attached to the door 11 interconnect when the door is in closed position by means of the ears 16 and 19. When the door 11 is in closed position, as illustrated in FIGS. 1,2, and 8, the ear 19 of the metal plate 20 attached to the door jamb 12, rests between the ears 16 of the metal plate 17 attached to the door 11.

As shown in FIGS. 1,2 and 8 there is an even space 22 between the two ears 16 of metal plate 17 attached to the door 11 and the ear 19 of the metal plate 20 attached to the door jamb 12. This space 22 prevents the ears 16 and 19 from getting stuck together and allows them to interlock without any problems.

As shown in FIGS. 1,2 and 8, the ears 16 and 19 longitudinally align so to allow the body of the pin 15 to pass through them. The arms 14 of the pin face downward and are positioned on the outside of the ears 16 and 19, while the stud head 13, protrudes above the ears.

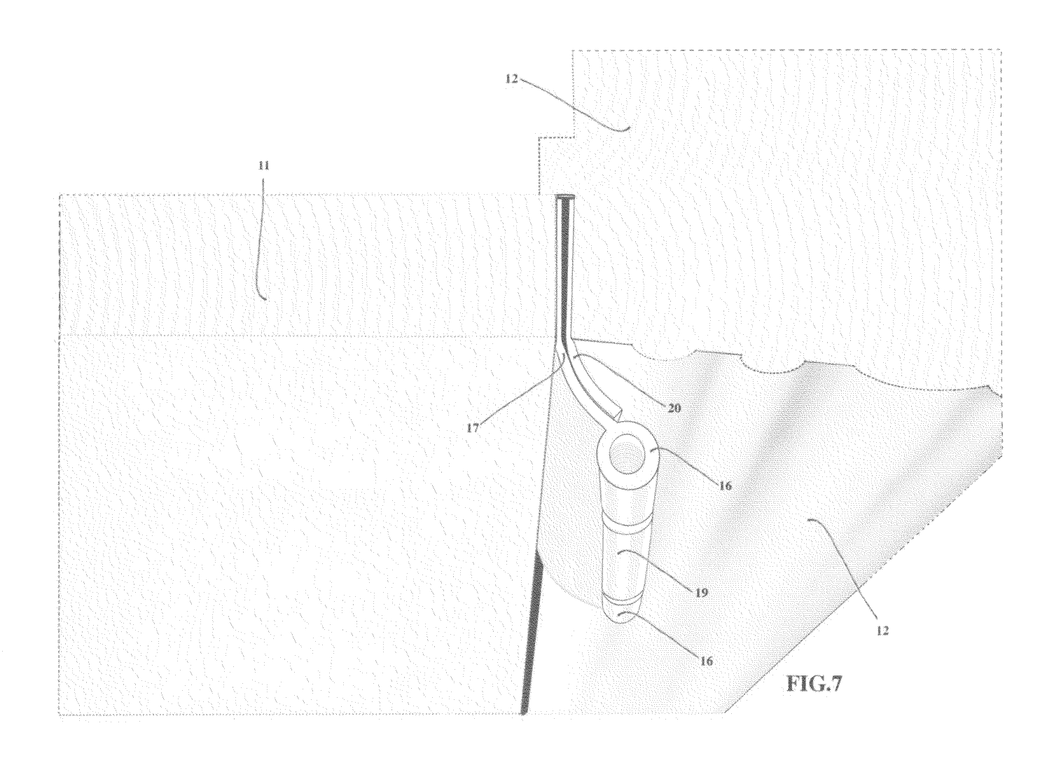

FIG. 7 is a cross sectional top front perspective view of the door guard, as shown in FIGS. 1-6 and 8-10, mounted on the door 11 and the door jamb 12 when the door is in closed position.

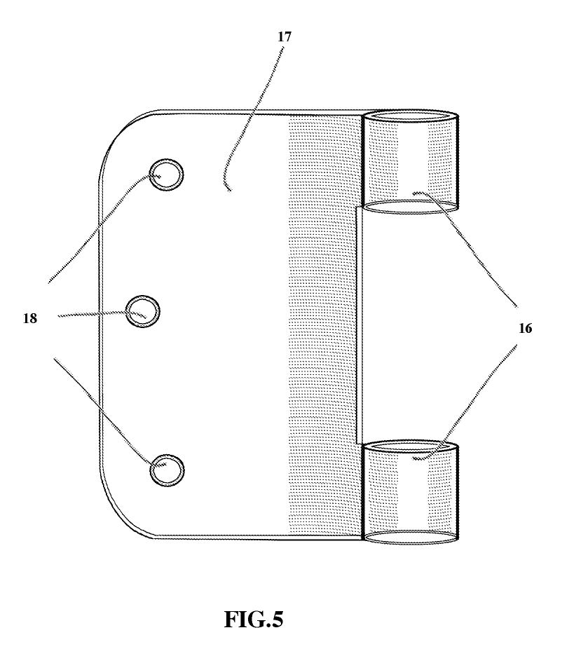

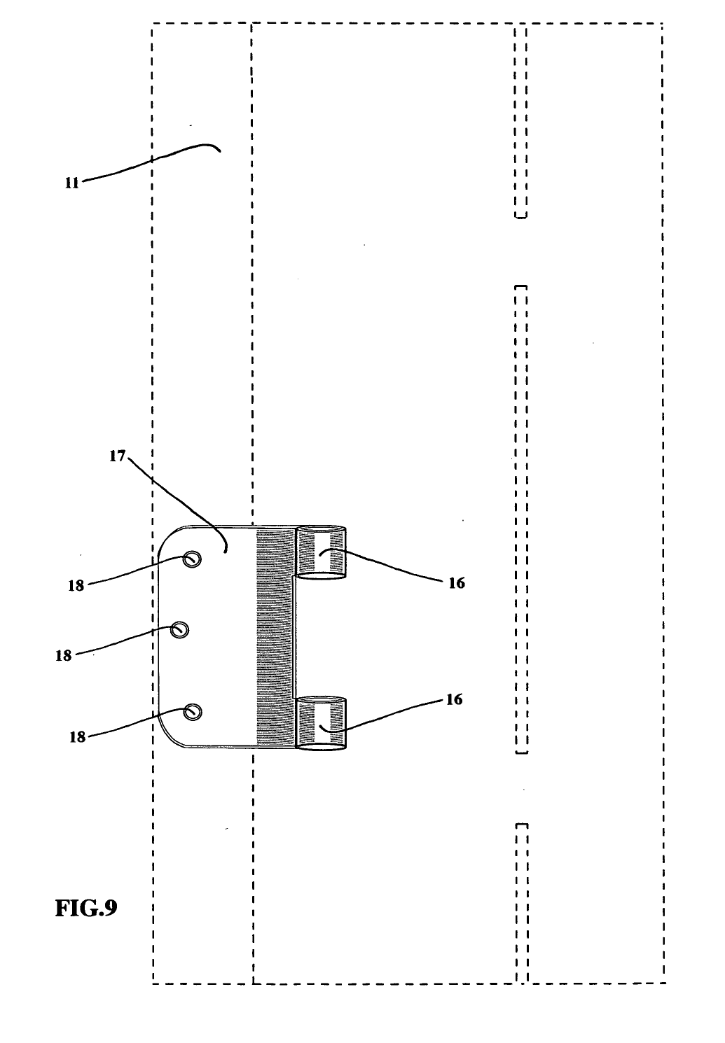

FIG. 9 Is a perspective view of the metal plate 17 attached to the door 11 as shown in FIGS. 3 and 5 with the door in open position.

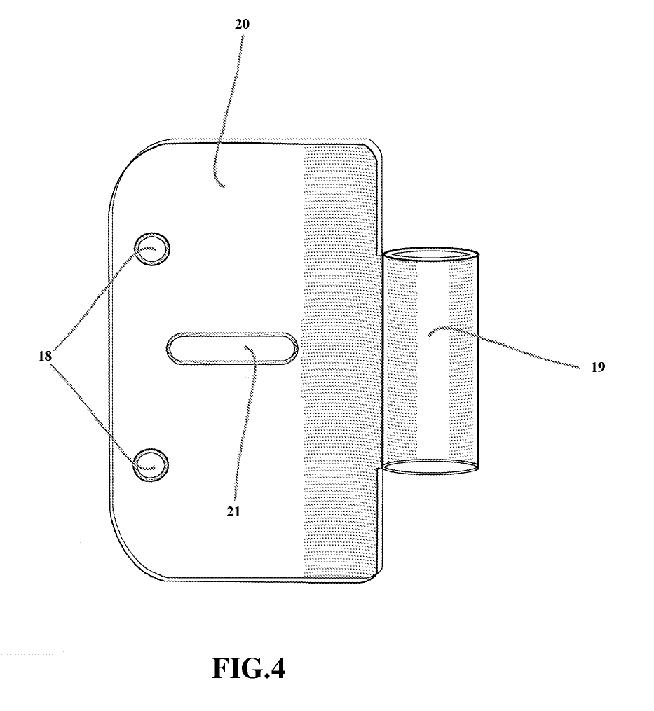

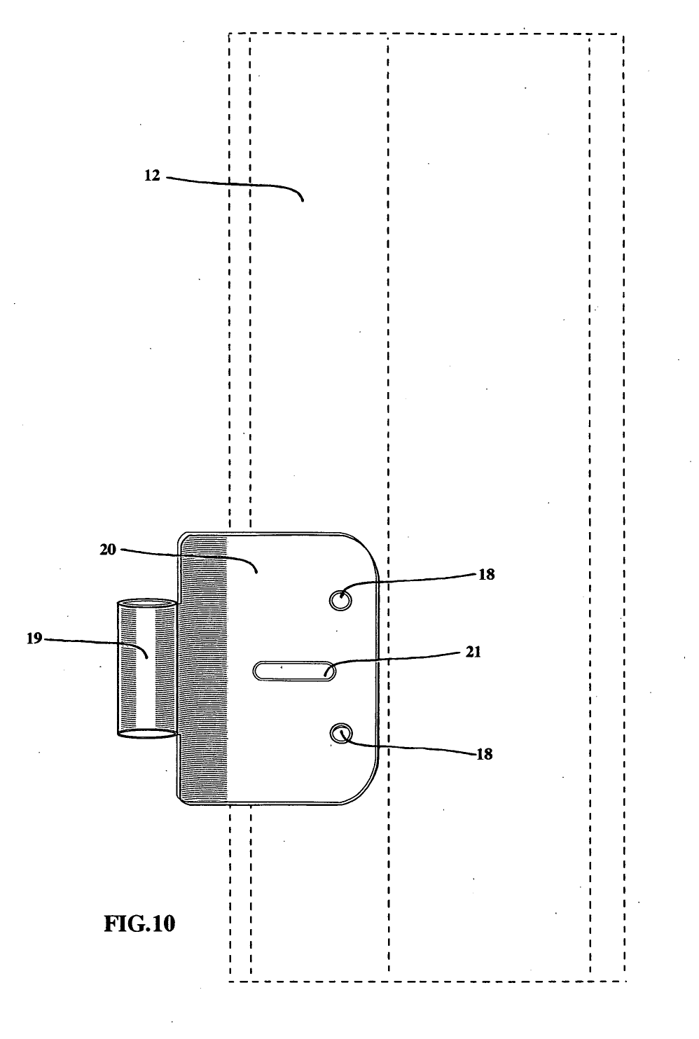

FIG. 10 Is a perspective view of the metal plate 20 attached to the door jamb 12 as shown in FIGS. 3 and 4 with the door in open position.

I claim:

1. A high security door guard lock device for protecting a door from forced entry where the door is used in conjunction with the door jamb and comprising:
A pair of cooperating metal plates which align perfectly when the door is closed
Said metal plates one being attached to the inside of the door and the other attached to the inside of the door jamb so as to be appositional to each other
Said metal plates being interconnected and cooperating when the door like member is closed
Said metal plate attached to the inside of the door having openings for screws so to be attached to the inside of the door
said plate having two shorter ears bent and extending externally towards the door jamb
Said plate being thicker towards the ear and thinner towards the inside of the door
Said metal plate attached to the inside of the door jamb being attached to the inside of the door jamb having openings for screws so to the attached to the inside of the door jamb, two of the screws being rounded and similar in side and a third being in the center and elongated so to allow adjustment of the plate on the door jamb
Said plate having one large ear bent and extending externally towards the door jamb
The ears of said plates which align so as to have the larger ear placed between the two shorter ears when the door is closed to define a bore for receiving a pin
A pin for insertion into said ears so to interlock said ears of said plates together when the door is in closed position
Said pin being comprised of a rounded stud head and two downward extending arms which secure on the outside of said ears of said plates.

2. The locking mechanism set in claim 1 wherein:
The ears of said plates align so to allow the pin to fit through the three ears when the door is closed

3. The locking mechanism set in claims 1 and 2 wherein:
There is an even space in the area between the ears when the ears are aligned and interlock.
